(19) United States
(12) Patent Application Publication
(10) Pub. No.: US 2023/0225263 A1
(43) Pub. Date: Jul. 20, 2023

(54) Cannabis Growing Apparatus

(71) Applicant: Gary Becker, Folsom, CA (US)

(72) Inventor: Gary Becker, Folsom, CA (US)

(21) Appl. No.: 17/579,223

(22) Filed: Jan. 19, 2022

(51) Int. Cl. A01G 22/00; A01G 9/12; A01G 7/04

(52) U.S. Cl. CPC A01G 22/00; A01G 9/12; A01G 7/045

(57) ABSTRACT

An improved apparatus for growing cannabis indoors with an improved vertical lighting system, raised horizontally disposed planters and vertical plant training wires. The cannabis plants are grown in horizontally disposed planters that are installed at a set raised height for easy access. A series of horizontally strung plant training wires are installed vertically above each row of plants. The lighting system is mounted to a powered vertical hanging system such that it can easily be raised and lowered into the space between the rows of plants

In an alternative embodiment of the invention, the planter rows are mounted on bearings such that they can be adjusted along the horizontal (x) axis. This allows for denser plant arrangement while still allowing for easy access between rows for plant training and maintenance.

### BACKGROUND OF THE INVENTION

### Field of the Invention

The present invention relates to the indoor farming of various crops, specifically cannabis. As various states legalize cannabis, the market for the crop is rapidly growing. Not only do consumers demand more and more supply, they also demand higher quality product comprising various unique strains each having different characteristics. Cannabis growers maintain tight control over the growing process to manage the quality and characteristics of their products.

While some cannabis is grown outdoors, like other traditional crops, much is grown indoors where the environment, including lighting, temperature, humidity and other environmental factors can be tightly controlled. Close control over these environmental factors allow the grower to more predictably produce cannabis of specific quality with the various characteristics desired such as THC level. While indoor growing provides many benefits, it also comes with costs such as indoor space and electricity. Cannabis growers are constantly striving to optimize the growth output per square foot while reducing electrical consumption and maintaining high quality product.

The present invention relates to an apparatus and method for growing cannabis that allows for optimal output and quality using reduced square footage and electricity. The novel apparatus and method described herein provides a substantial improvement in yield, defined as cannabis output per square foot. The computer controlled lighting and environment provide optimal grow characteristics while using only the minimum electricity necessary. The vertical training and vertically disposed lighting provide optimal light coverage to the plant canopy resulting in fast, efficient and high yeild grows.

### SUMMARY OF THE INVENTION

A novel apparatus and method for growing cannabis indoors is disclosed. The novel apparatus and method allow for more plants to be grown in a given square footage and to produce more output from the same number of plants.

The improved apparatus includes an improved vertical lighting system, a computerized lighting control system, a powered vertical lighting hanging system, raised horizontally disposed planters and vertical plant training wires. The improved lighting system comprises vertically disposed lighting located between rows of plants. The light system radiates the optimum bandwidth light for plant growth in an even 180 or 360 degree pattern that efficiently covers the maximum amount of the plant canopy. The lighting system is compact, low heat and draws lower levels of electricity than traditional incandescent or fluorescent lighting systems. The timing, bandwidth and intensity of the light are automatically controlled with a computerized control system, as are other environmental factors such as temperature, humidity and soil moisture levels.

The cannabis plants are grown in horizontally disposed planters that are installed at a set raised height for easy access. The planters are arranged in rows such that the grower can easily walk between the rows and tend the plants. A series of horizontally strung plant training wires are installed vertically above each row of plants. These wires allow the plants to be trained to grow vertically to allow the plant canopy to be grown so that the maximum surface area possible is exposed to the lighting.

The lighting system is mounted to a powered vertical hanging system such that it can easily be raised and lowered into the space between the rows of plants. This allows the lights to be moved out of the way for easy access to the rows of the plants.

In an alternative embodiment of the invention, the planter rows are mounted on bearings such that they can be adjusted along the horizontal (x) axis. This allows for denser plant arrangement while still allowing for easy access between rows for plant training and maintenance.

In another alternative embodiment of the invention, the planter rows are mounted on hydraulic lifting devices between a storage and maintenance location. The storage location includes rows of lighting that cover both sides of the plant. The plant rows are lowered for plant maintenance, trimming and harvesting.

The disclosed method includes planting cannabis plants in raised planters arranged in rows above the ground for easy access, locating vertically disposed lights arrayed such that the emit light in a 360 radiation pattern. The method also includes raising and lowering the vertical lights to provide access to the plants and training the plants to grow vertically on horizontally disposed wires. Lastly, the lighting is computer controlled to provide optimal conditions for plant growth.

### BRIEF DESCRIPTION OF THE DRAWINGS

FIG. 1 is a plan view of the complete cannabis growing apparatus.

FIG. 2 is a view facing down a row of cannabis plants with the vertical lighting in the down position.

FIG. 3 is a view facing down a row of cannabis plants with the vertical lighting in the raised position.

FIG. 4 is a row of vertical lighting fixtures shown without plants in the down position.

FIG. 5 is a row of vertical lighting fixtures shown with plants in the down position.

FIG. 6 is a row of vertical lighting fixtures shown with plants in the raised position.

FIG. 7 is a view of horizontal training wires with Unistrut framing.

FIG. 8 is a view of the floor plan of the grow building.

FIG. 9 is a view of the computer control system, sensors and environmental adjustment devices.

FIG. 10 is a view of an embodiment with rolling rows of cannabis plants.

FIG. 11 is an end view down a plant row with the gear rack shown.

FIG. 12 is an expanded view of the gear mechanism for the rolling rows.

FIG. 13 is a view of the watering mechanism.

FIG. 14 is a view of the ballast rack for the lighting system.

FIG. 15 is a view of an embodiment with plant rows moved with a hydraulic lift.

FIG. 16 is a view of an embodiment with plant rows moved with a hydraulic lift and plants grown in rockwool cubes.

FIG. 17 is an end view of a plant row.

FIG. 18 is an end view of a plant row with rockwool cubes.

FIG. 19 is a side view of a plant row with hydraulic lift.

FIG. 20 is a top view of plant rows with lighting.

### DESCRIPTION OF THE PREFERRED EMBODIMENT

Cannabis growers have been developing new apparatus and methods for improving the quality and yield of their crops, both indoor and outdoor, for many years. With the legalization of cannabis in many large states, the pressure to increase quality and yield has only grown. Indoor grows are well known for the quality of their output due to the close control allowed for the environmental conditions. However, there is a significant space and electrical cost to these types of growing arrangements. The present invention describes an apparatus and method that arranges the plants and lighting in such a way to optimize the space needed, improve the yield per square foot of space, provide easy access to the plants for the grower, lower the electrical cost per pound grown and provide improved quality cannabis output. The novel apparatus and method results in a significant increase in yield and an output of over one gram per watt of electricity consumed.

A preferred embodiment of the disclosed invention is described in relation to the attached figures and claims below. This is but one embodiment and there are many other variations and embodiments that comport with the patent claims.

As will be discussed in the detailed description below, the disclosed invention provides a novel and improved apparatus and method for indoor growing of cannabis. As outlined in detail below, the present invention includes: a row of horizontally disposed planters arranged in parallel rows, vertically disposed posts at each end of the row of planters, the vertically disposed posts including key type slots cut at locations along the length of the post, with wires strung between each vertical post and held in place in the key slot by a plug attached to the wire at each end. The preferred embodiment further comprises movable vertical lighting units that can be raised and lowered in the rows between the planters, these lighting units comprising, vertically lighting stands, each with lights vertically arranged along the length of the stand and such that the lights provide an even 360 degree pattern of lighting around the lighting stand, lighting stands arranged in rows located between the rows of planters. Wires, electric motors and pulleys allow the lighting stands to be positioned in a raised position so that the grower can easily walk between the rows of plants or lowered position to provide lighting for the plants. Finally, the disclosed invention provides computer control for the wavelength, intensity and timing of the LED lighting disposed along the lighting stands as well as other environmental factors such as temperature, humidity and soil moisture.

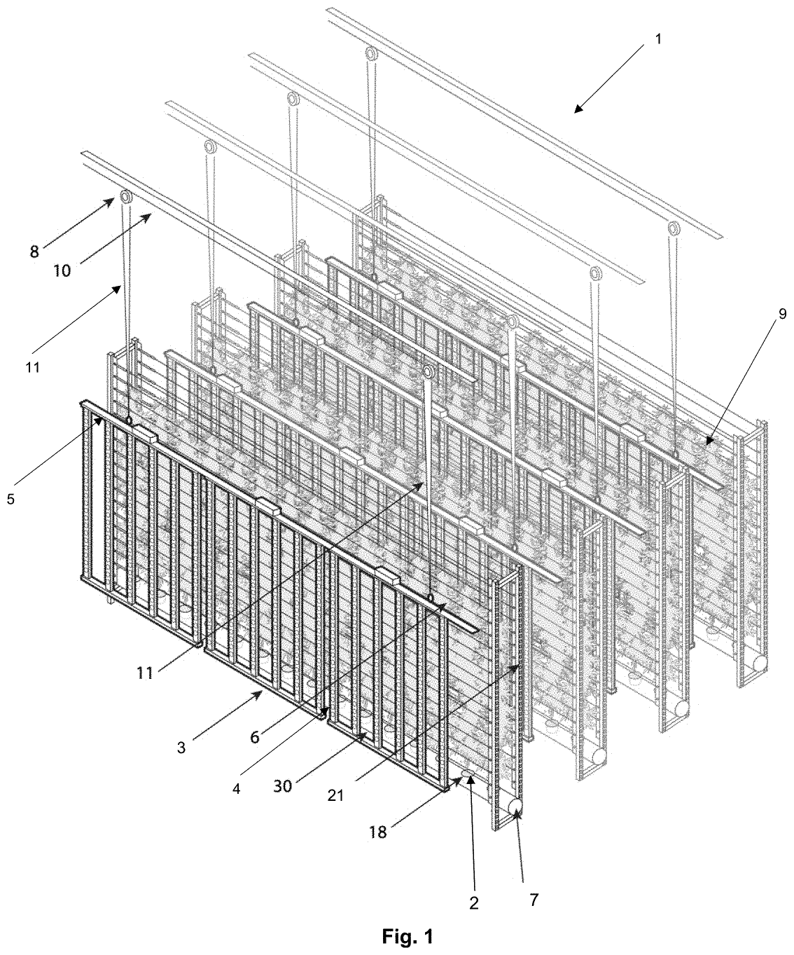

FIG. 1 shows a plan view of the improved cannabis growing system 1 of the claimed invention. Cannabis plants 6 are planted in a number of potting containers 2 which arranged in a row 30 and held by plant support 7 in a series of plant holes 18. Any number of cannabis plants 6 can be included in each row 30, but 15 cannabis plants per row 30, supported in plant support 7, is the number used in this disclosed preferred embodiment.

Each of these rows 30 is framed by Unistrut, which is the trademark name for a metal slotted channel material with various attachment means such as brackets, channel nuts, threaded rods and clamps, shown by upper support 5 and lower support 3 in this diagram. Additional elements of the Unistrut supports will be shown in other figures. Horizontal training wires 9 are extended horizontally along each row 30 of cannabis plants 6. A number of horizontal training wires 9 are disposed vertically above each row of cannabis plants. These horizontal training wires 9 are used to train the growth of the cannabis plants 6 vertically so that the plant canopy will be exposed to the maximum amount of light. In the preferred embodiment, training wires 9 are placed three inches (3″) apart and are made of 3/64 inch stainless steel wire rope. Other configurations of training wires 9, including different spacing and/or vertical placement, as well as different materials are anticipated by the present disclosure.

Vertical light fixture 4 is disposed between each row 30 of cannabis plants and is comprised of multiple LED lighting elements arranged in a vertical pattern along the length of the fixture. Any number, arrangement and wavelengths of light for the LEDs are anticipated by the claimed invention, but the preferred lighting specifications will be discussed in relation to later figures.

Each vertical light fixture 4 is attached to height adjustment cable 11. This height adjustment cable 11 is routed through pulley 8 to main cable 10 and to motor 12. Motor 12 can be powered to raise and lower the vertical light fixtures 4 from in between each row 30. In the lowered position, they provide an even and well distributed 360-degree lighting pattern and in the raised position, they are out of the way for maintenance and tending of the plants.

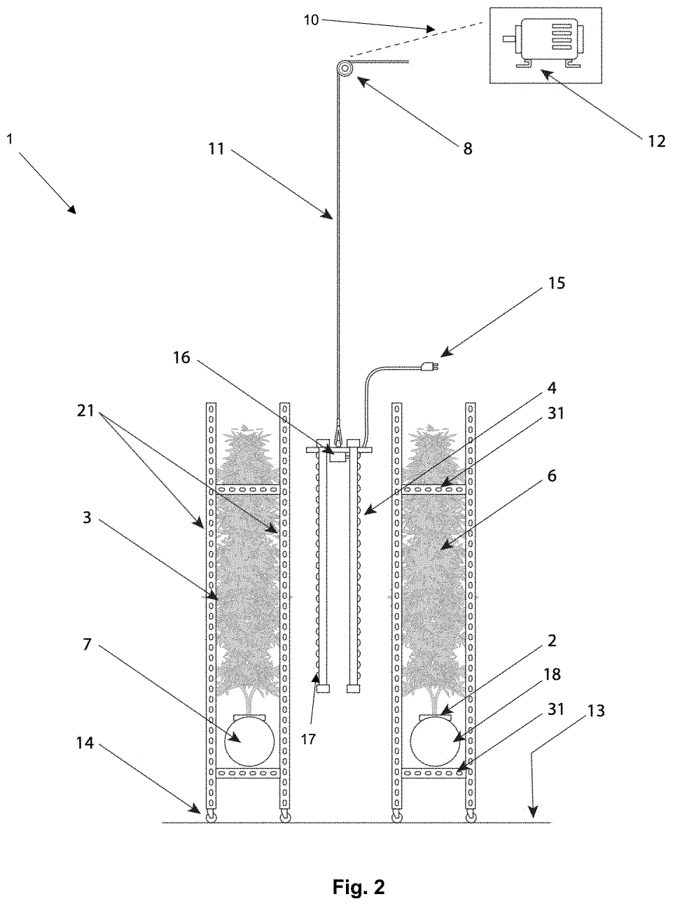

FIG. 2 shows a view of the improved cannabis growing system 1 looking down a row 30 with a side view of horizontal lighting fixture 4. In this view, horizontal lighting fixture 4 is in the lowered position, where it provides efficient 360-degree lighting for plants on both sides of row 30. Plant support 7 is shown with cannabis plant 6 disposed in potting container 2 which is held in plant hole 18. In the preferred embodiment, plant support 7 is formed from a length of 12-inch PVC schedule 40 pipe mounted approximately two feet from the floor between the vertical support members 21. Installation of the plant support member 7 above the floor is optimal for the grower to have access to the plant without having to bend or stoop to reach the potting container. Plant holes 18 are drilled in the PVC pipe at suitable intervals, in the preferred embodiment 18″ from center to center, each plant hole 18 designed to fit a single potting container 2 for one cannabis plant 6. The potting containers 2 are one foot/12 inch diameter plastic containers, but any suitable planting container is acceptable. The containers contain soil and other items that provide the optimal growing environment for the cannabis plant roots. The potting containers 2 provide suitable drainage to allow water to drain through the soil and out of the container into the PVC pipe. The PVC pipe is angled at a slight decline to provide a suitable path for water runoff to the drain, located at the end of each PVC pipe (not shown).

Vertical light fixture 4 is comprised of individual LED lighting units 17. These light fixtures are comprised of vertically oriented aluminum rails with individual LED lighting units mounted along the length of the rail. Lights can be installed on one side or both sides of the aluminum rails providing either 180 degrees of lighting coverage or 360 degrees of lighting coverage. In the preferred embodiment, the lighting is Fluence Bioengineering LEDs in a mixture of wavelengths, each light having a 345 watt output. The vertical lighting units are designed such that they line up with the vertically trained cannabis plants and provide maximum light coverage for the maximum amount of plant foliage.

Lighting ballast 16 converts the 120 volt AC electricity from the wall to the appropriate voltage and current for the LED lighting units 17. Power is provided through power connection 15 that is connected to the electric supply of the building, which is, in turn, connected to a commercial electricity supply company.

The individual LED lighting units 17 are also connected via a communications cable (Not pictured) that is connected to a computer control system. This computer control system will be described in greater detail in a later figure. Communications cable is of a typical CAT 5/6/6a/7/7a/8 variety. This communications cable allows the computer control system to control each of the following individual LED lighting characteristics: on/off, brightness and wavelength. The computer control system includes an algorithm that determines the lighting schedule and characteristics that are best suited for optimum growth. Other types of communication cable or methods are anticipated by this system including a variety of wireless means such as WiFi and Bluetooth connected devices.

The vertical light fixture 4 is vertically positioned by height adjustment cable 11, which is routed through pulley 8, to main cable 10 and then to motor 12. Motor 12 provides rotational energy in one direction to raise the vertical light fixture 4 and in the opposite direction to lower vertical light fixture 4. FIG. 2 shows the vertical light fixture 4 in its lowered position.

Lastly, plant members 7 by vertical supports 21 and horizontal supports 31. Casters 14 are positioned at the bottom of vertical supports 21 and within track 13 and allow individual rows 30 to be moved along the x or horizontal axis. This allows more rows to be contained in the same space. They can be moved horizontally to provide access or to compress the rows to save space.

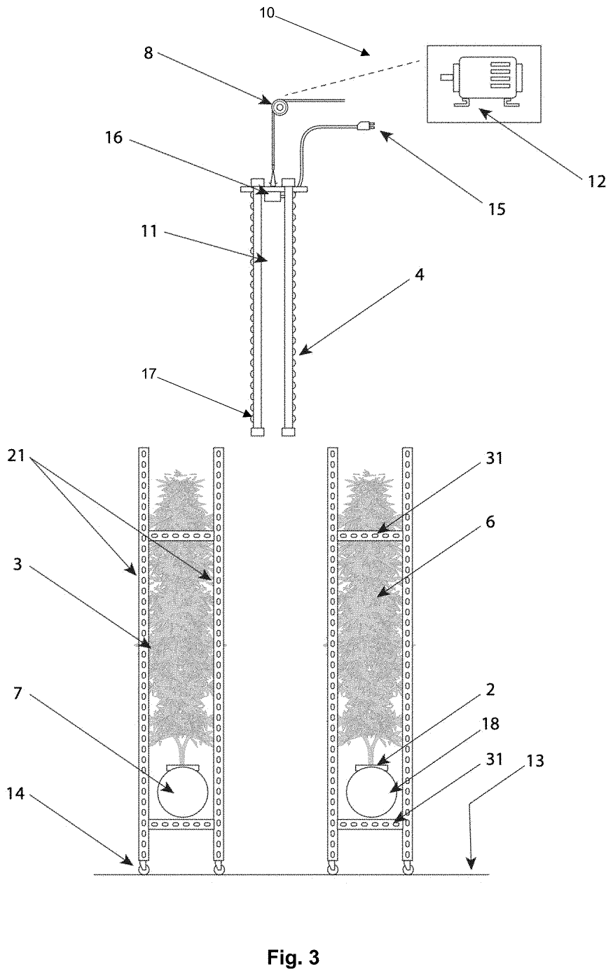

FIG. 3 is shows the same side view down row 30 as in FIG. 2 but with vertical light fixture 4 in the raised position to allow access to the aisles between rows 30.

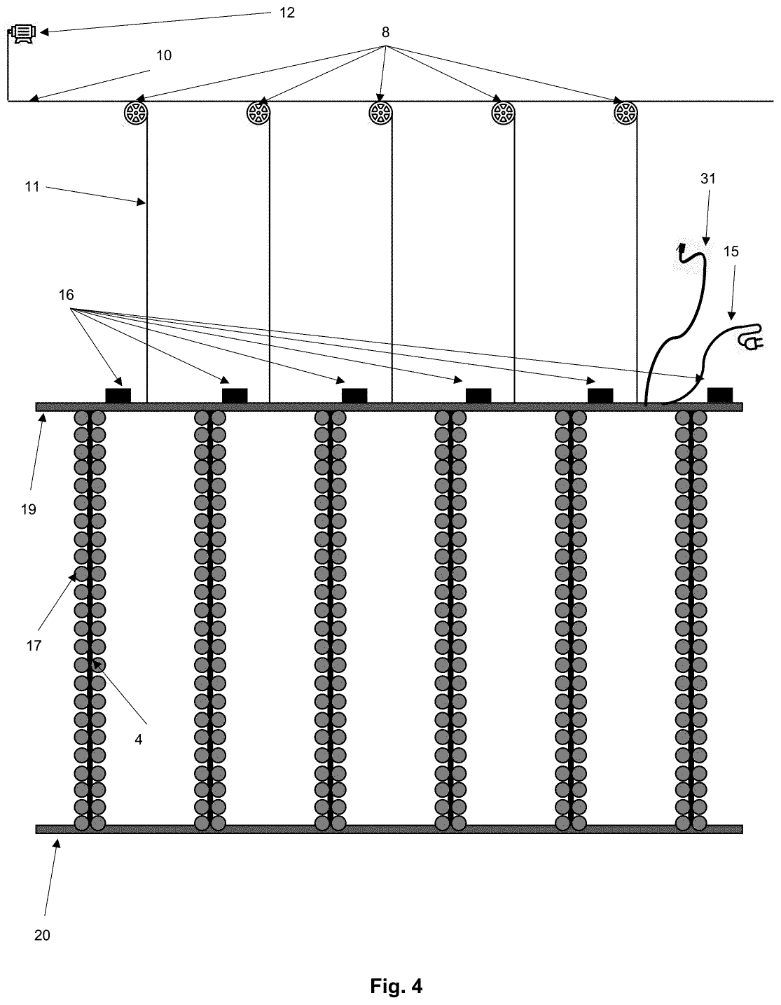

FIG. 4 provides a view of multiple vertical lighting fixtures 4. In this view, upper lighting support 19 and lower lighting support 20 are visible. Multiple ballast units 16 are attached to upper support unit 19 in the preferred embodiment, but many other configurations are anticipated with ballast units installed in other locations or potentially not required, based on the type of LED used. As in prior figures, vertical lighting fixture 4 is vertically positioned by height adjustment cable 11, which is routed through pulley 8, to main cable 10 and then to motor 12.

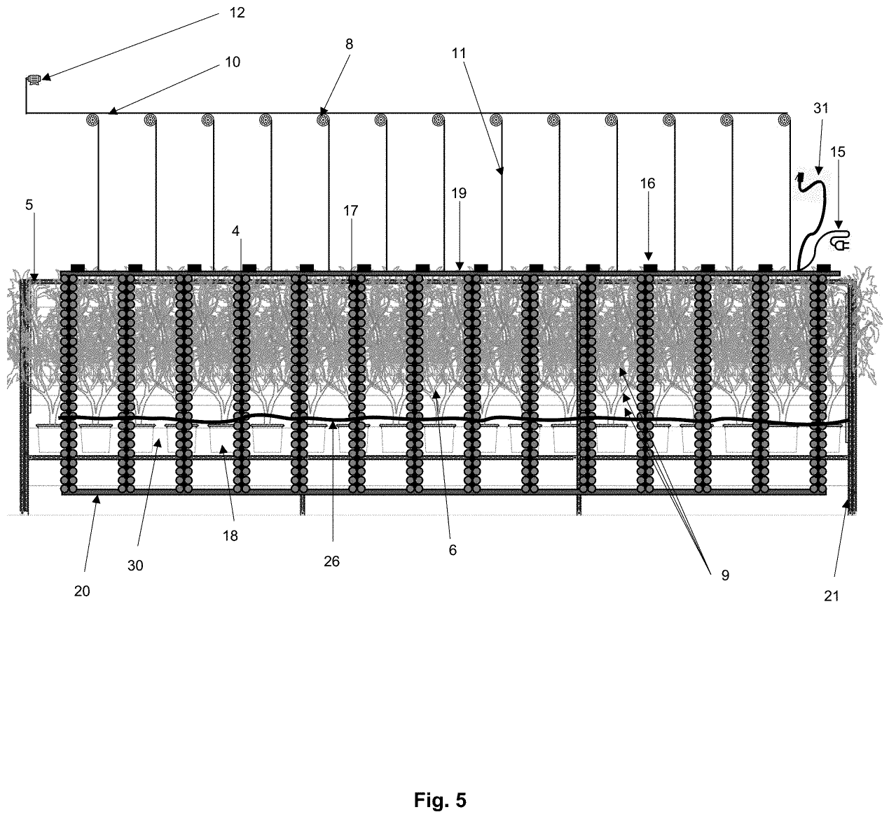

FIG. 5 shows a side elevation view of a single row 30 of the complete improved cannabis growing system. As shown in the prior figures, a row of cannabis plants 6 are planted in potting container 2 each of which are positioned in plant hole 18 and supported by plant support 7. Unistrut support members including upper support member 5, lower support member 3 and vertical support member 21 (with one at each end of the row). These Unistrut support members hold the plant support 7 but also provide a frame for horizontal training wires 9, a number of which extend vertically up from the cannabis plants 6. As described in the prior figures, horizontal training wires 9 provide support for the cannabis plant canopy to grow vertically.

Horizontal training wires 9 are strung along the length of each row of plants in intervals above each row. These training wires are manufactured of aircraft grade stainless steel wire, located in intervals of 3″-4″. In the preferred embodiment, there are 48 training wires located above each row. The wires are attached to L channel rails attached to the vertical support members 21 at the end of each row. Wires are attached with nuts and tension adjusters at one end of the wire. Tension adjusters allow tightening and loosening of the tension on the wire. At the opposite end of the wire, a copper plug is attached to the end of the wire. The L channel rail at that end has keyhole slots cut in it at suitable intervals to match the desired intervals of the wire. The copper plug can be slid through the circular portion of the keyhole slot and held in place by the copper plug secured in the slot. Using the tension adjusters at the opposite end, the tension can be increased to firmly hold the wire in place or loosened so the copper plug can be slid through the circular portion of the keyhole slot to detach the wire. The training wires are used to train the cannabis plants to grow vertically.

This vertical training of the plants arranges them in a way that allows the maximum surface area of the plant leaves to be impacted with light from the lighting apparatus. The more surface area of the plant that can be impacted with light increases the amount of photosynthesis and thus the growth of the plant. This vertical training of the plants also has the added benefit of making the plants easy to work on in rows at standing height.

Horizontal lighting fixtures 17 comprising individual LED lighting elements 4 are shown attached to upper lighting support 19 and lower lighting support 20, each providing support for the horizontal lighting fixtures. Height adjustment cable 11 is attached to the upper lighting support 19 as are each of the lighting ballasts 16. Height adjustment cable 11 is routed through pulleys 8 to main cable 10 and motor 12. Rotational energy from motor 12 is used to move the entire lighting unit up and down depending on the direction of motor rotation. Height adjustment cable and main cable are manufactured of aircraft grade stainless steel wire, similarly to the training wires, though any suitable cable material known in the art could be used, including steel, aluminum, copper, plastics, composites or other materials.

In this view, watering system 26 is shown installed for each potting container. In the preferred embodiment, this system is computer controlled to provide the optimal amount of water and the correct time for best plant output. The system is built out of standard landscaping materials, with piping routed between the top of each of the planting containers. A suitable water controller is attached to the main water supply and then the end of each row of piping to appropriately control water flow. This water controller is attached to the computer control system through communications cable 31 or other communication means such as WiFi or Bluetooth.

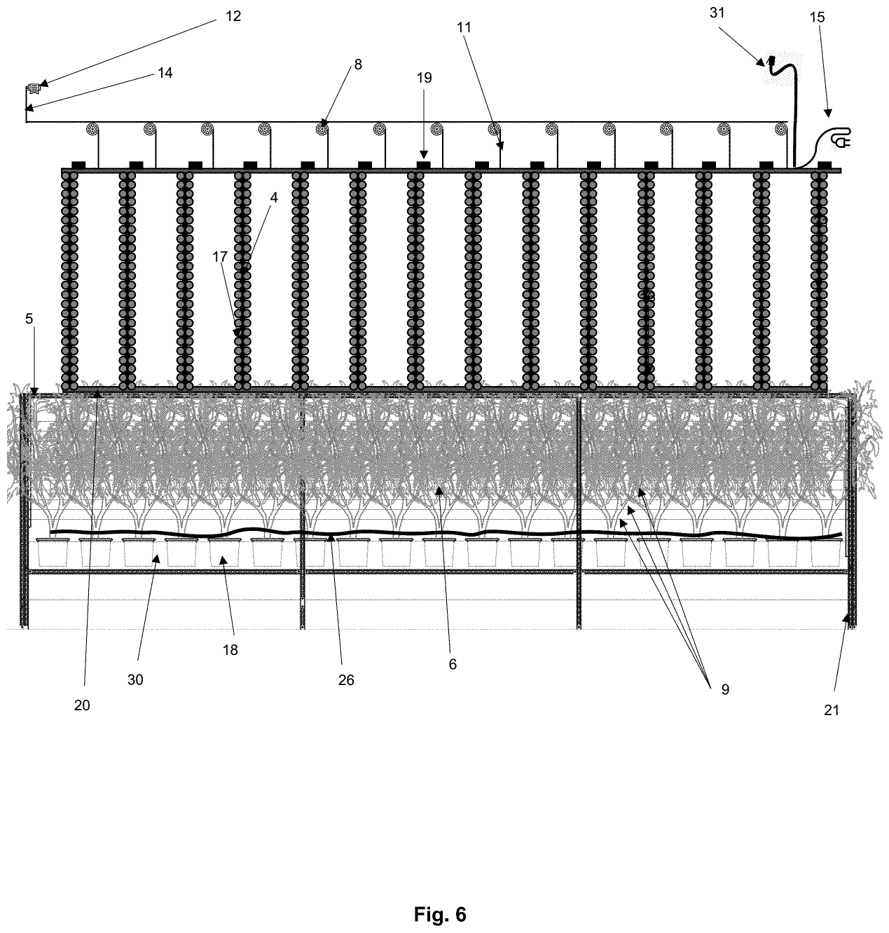

FIG. 5 shows the horizontal lighting units in the down position. FIG. 6 shows them raised out of the row 30.

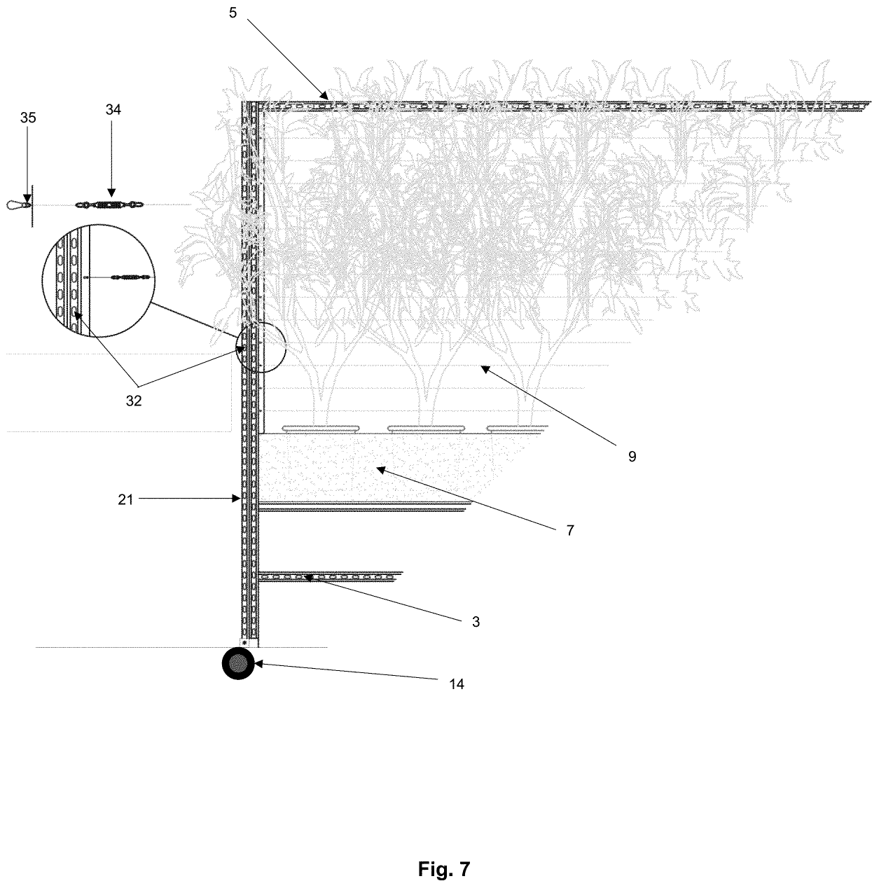

FIG. 7 shows a view of the upper support member 5, lower support member 3, and vertical support member 21 with training wires 9 attached. Each training wire is connected to vertical support member 21 at attachment point 32. In the preferred embodiment, there are 48 training wires 9 located above each row. The wires are attached to L channel rails attached to the vertical support members 21 at the end of each row. Wires are attached with nuts and tension adjusters 34 at one end of the wire. Tension adjusters 34 allow tightening and loosening of the tension on the wire. At the opposite end of the wire, a copper plug 35 is attached to the end of the wire. The L channel rail at that end has keyhole slots cut in it at suitable intervals to match the desired intervals of the wire. The copper plug 35 can be slid through the circular portion of the keyhole slot and held in place by the copper plug secured in the slot. Using the tension adjusters 34 at the opposite end, the tension can be increased to firmly hold the wire in place or loosened so the copper plug 35 can be slid through the circular portion of the keyhole slot to detach the wire.

Plant support member 7 is shown as are casters 14 that allow the row to move horizontally.

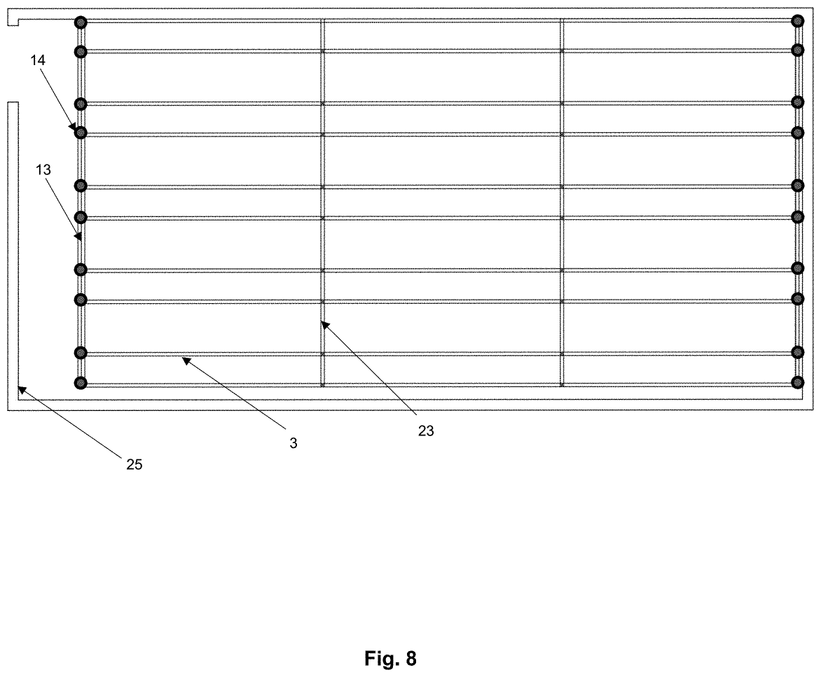

FIG. 8 shows plans for the lower support members 3 of each row. Cross support members 23 are disposed at various lengths to provide additional connection points and support. Building walls 25 are shown for reference. Additionally, track 13 and casters 14 are shown to indicate where the rows can be moved horizontally. Casters 14 are contained in track 13 which allows free movement of the rows.

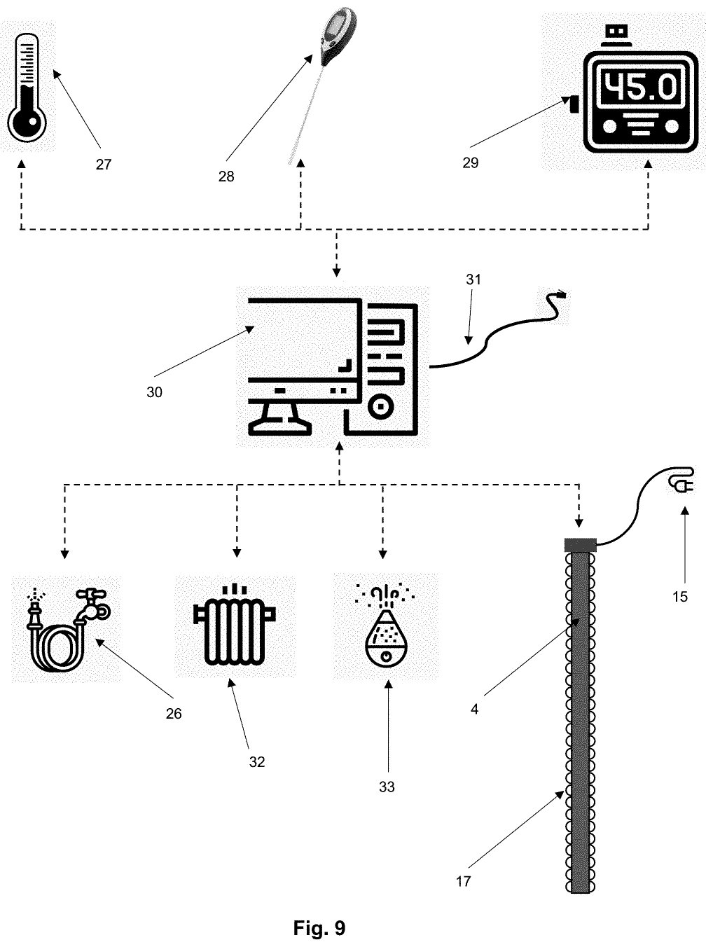

FIG. 9 shows the various elements of the computer control system of the preferred embodiment. Computer 30 is attached to various sensors including temperature sensor 27, soil moisture sensor 28 and ambient humidity sensor 29. These sensors measure the key environmental factors in the growing environment. These environmental factors directly relate to the health and yield of the cannabis plants in the grow environment. In addition to sensors, the computer control system also can adjust the watering system 26, heater 32, humidifier 33 and vertical lighting system 17 to create optimal growth conditions. Further, computer control system allows input of various growth factors by the user so it can use such data in modeling algorithms for ideal grow conditions and optimal yield.

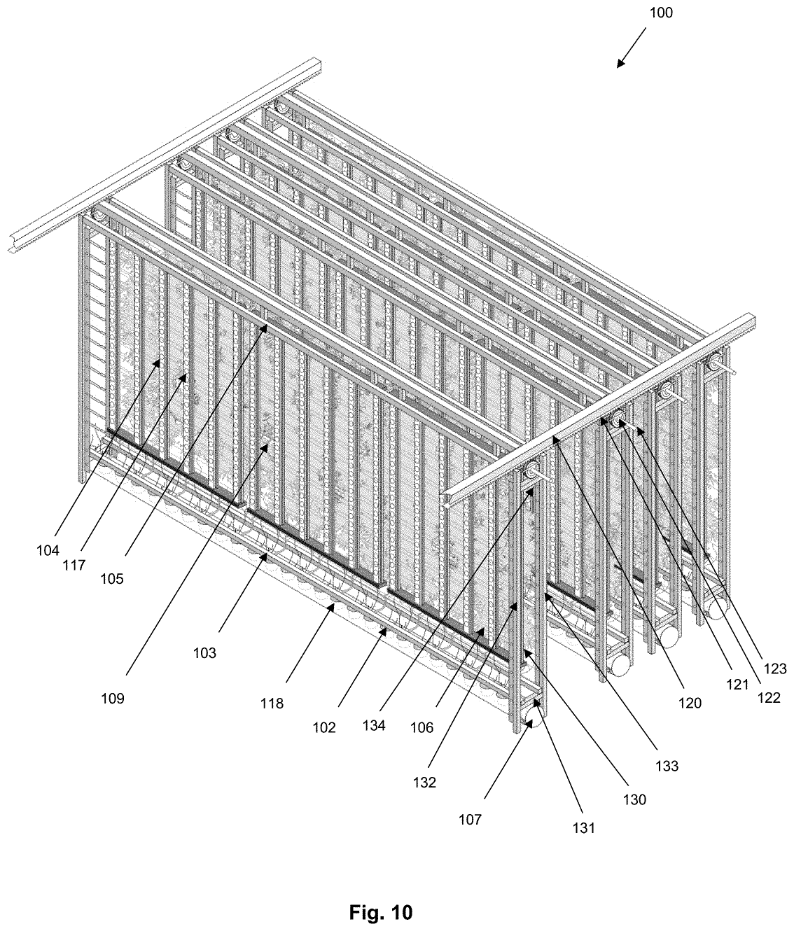

FIG. 10 shows an alternate embodiment of the improved cannabis growing system 100. In this embodiment, cannabis plants 106 are planted similarly to the prior embodiment, with each cannabis plant potted in a potting container 102 which are arranged in rolling rows 130 and held by plant support 107 in a series of plant holes 118. In this embodiment, rolling rows 130 are disposed to roll horizontally along the horizontal axis. These rolling rows 130 allow the rows to be positioned pushed together for maximum grow density during normal grow and storage times but also to be rolled apart so that workers can enter a row between rows for plant maintenance. In this embodiment, the vertical light fixtures 104 are fixed vertically, but move with the rolling rows 130. The rolling row 130 mechanism and specifications are described below.

Rolling row 130 is supported by row support 120. Row support 120 is manufactured with suitable high strength aluminum or any other appropriate high strength metal, such as steel. In the preferred embodiment, row support 120 is made from 4″×1/4″ aluminum bar.” Disposed within row support 120 is gear rack 121. Gear rack 121 provides one side of suitable gear teeth to connect the matching gear teeth within row movement gear 122. Gear rack 121 is printed using a 3D (three dimensional) printer and, in the preferred embodiment, made from a high durability material such as chopped carbon fiber nylon mixture. In the preferred embodiment, the dimensions of gear rack 121 are infinitely variable due to being 3D printed, but any suitable dimension or high durability material could be used within the claims of the present invention, including an off the shelf gear rack. Row movement gear 122 is a circular gear with matching teeth to the gear rack 121. When rotated, row movement gear 122 the gear teeth disposed around the circumference engage with the gear teeth of the gear rack 121 to move the rolling row 130 in either horizontal direction. The row movement gear 122 is disposed and attached to support pipe 123. In the preferred embodiment, support pipe 123 is manufactured of ¾″ steel pipe, but any suitable high strength material could be used. This steel pipe is located along the top of each rolling row 130, with row movement gears 123 located at both ends. Support pipe 123 travels through four ball bearing collars along the length of the pipe. These ball bearing collars provide smooth and easy rotation of support pipe 123. Rotation of support pipe 123 engages row movement gear 122 with gear rack 121 and provides smooth movement of rolling row 130. Rotational energy can be applied manually, by hand, to support pipe 123, with a handle (not show) or a pulley and electric power. Such an electric motor could be computer controlled and included in the overall control system for the growing system.

Row supports 120 with gear rack 121 and row movement gear 122 are located at both ends of the rolling row 130 and disposed along support pipe 123. In the preferred embodiment, rolling row 130 can be opened to provide 3 feet of clearance between the rows. Each row supports a cannabis plant canopy of 46″ and a grow of 9.6 lbs of cannabis. These specifications relate to the preferred embodiment, but the invention is not so limited.

In each rolling row 130, cannabis plants 106 are planted in potting containers 102. Plant holes 118 are formed in plant support 107 in a size to fit potting containers 102. In the preferred embodiment, plant support 107 is formed from a length of 12-inch PVC schedule 40 pipe mounted approximately two feet from the floor between the vertical support members 132 and 133, though the height from the ground is variable depending on the needs of the growing area. Installation of the plant support member 107 above the floor is optimal for the grower to have access to the plant without having to bend or stoop to reach the potting container. Plant holes 118 are drilled in the PVC pipe at suitable intervals, in the preferred embodiment 12″ to 16″ from center to center, each plant hole 118 designed to fit a single potting container 102 for one cannabis plant 106. The potting containers 102 are one foot/12 inch diameter plastic containers, but any suitable planting container is acceptable. The containers contain soil and other items that provide the optimal growing environment for the cannabis plant roots. The potting containers 102 provide suitable drainage to allow water to drain through the soil and out of the container into the PVC pipe. The PVC pipe is angled at a slight decline to provide a suitable path for water runoff to the drain, located at the end of each PVC pipe (not shown). Any number of cannabis plants 106 can be included in each row 130, but 15 cannabis plants per row 130, supported in plant support 107, is the number used in this disclosed preferred embodiment.

Vertical light fixtures 104 are disposed between each rolling row 130 of cannabis plants and is comprised of multiple LED lighting elements arranged in a vertical pattern along the length, front and back of the light fixture. Vertical light fixture 104 is comprised of fifty individual LED lighting units 117 on each of the front and back of the vertical fixture 104. These light fixtures are comprised of vertically oriented aluminum rails with individual LED lighting units mounted along the length of the rail. Lights are installed on both sides of the aluminum rails providing 360 degrees of lighting coverage. In the preferred embodiment, the lighting is Fluence Bioengineering LEDs in a mixture of wavelengths, each light having a 345 watt output. The vertical lighting units are designed such that they line up with the vertically trained cannabis plants and provide maximum light coverage for the maximum amount of plant foliage.

The individual LED lighting units 117 are also connected via a communications cable (Not pictured) that is connected to a computer control system. This computer control system will be described in greater detail in a later figure. Communications cable is of a typical CAT 5/6/6a/7/7a/8 variety. This communications cable allows the computer control system to control each of the following individual LED lighting characteristics: on/off, brightness and wavelength. The computer control system includes an algorithm that determines the lighting schedule and characteristics that are best suited for optimum growth. Other types of communication cable or methods are anticipated by this system including a variety of wireless means such as WiFi and Bluetooth connected devices.

Each of the rolling rows 130 is framed by Unistrut, shown by upper support 105 and lower support 103 in this diagram. Horizontal training wires 109 are extended horizontally along each row 130 of cannabis plants 106. A number of horizontal training wires 109 are disposed vertically above each row of cannabis plants. These horizontal training wires 109 are used to train the growth of the cannabis plants 106 vertically so that the plant canopy will be exposed to the maximum amount of light.

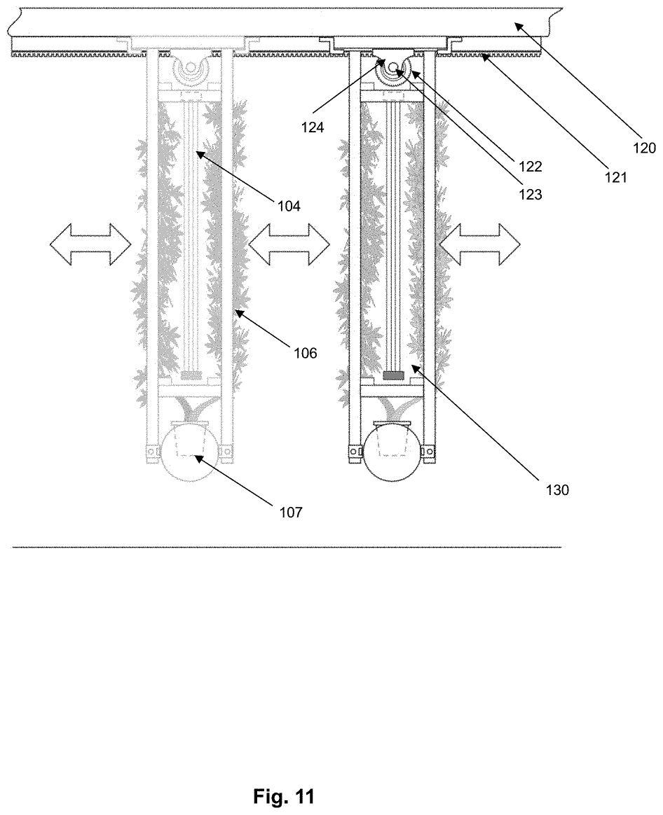

FIG. 11 provides a side view two rolling rows 130. This view shows the horizontal motion of the rolling rows 130. Rolling rows 130 are supported by row support 120. Gear rack 121 is attached to row support 120 and couples with row movement gear 122. Row movement gear is disposed around support pipe 123. Ball bearing collar 124 provides a smooth reduced friction rolling motion for support pipe 123. As described above, gear rack 121 is 3D printed out of a durable high strength material and is designed to couple with the gear pattern of row movement gear 122. Rotation of support pipe 123 causes rotation of row movement gear 122, which is coupled by gear teeth to gear rack 121. Movement of row movement gear 122 results in movement of the entire rolling row 130. A set of row support 120, gear rack 121 and row movement gear 122 is located at each of the rolling row 130. Further, a ball bearing collar 124 is located at each end, with two additional ball bearing collars 124 located along support pipe 123 to provide support and rotational support.

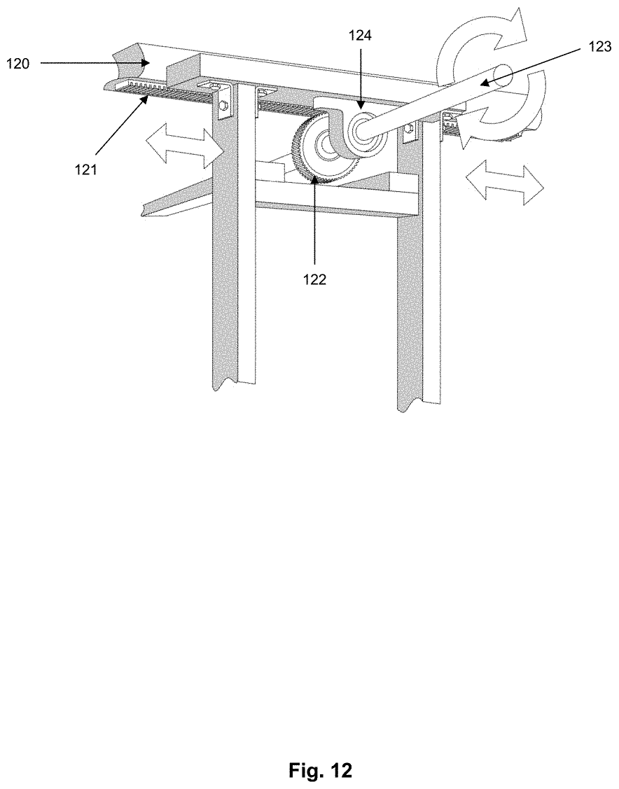

FIG. 12 shows a more detailed view of the rolling row 130 gear mechanism. Row support 120 is shown with gear rack 121 attached on the lower side. Row movement gear 122 is coupled to gear rack 121 by the matching gear teeth. When support pipe 123 is rotated as shown in FIG. 12, the gear teeth on row movement gear 122 couple with the matching gear teeth on gear rack 121 to provide horizontal motive force. Ball bearing collar 124 supports support pipe 123 with the ball bearings providing low rotational friction for easy movement. While one ball bearing collar 124 is shown here, in a typical row, there would be four such collars, with one located at each end and two along the length of the support pipe between the two row ends.

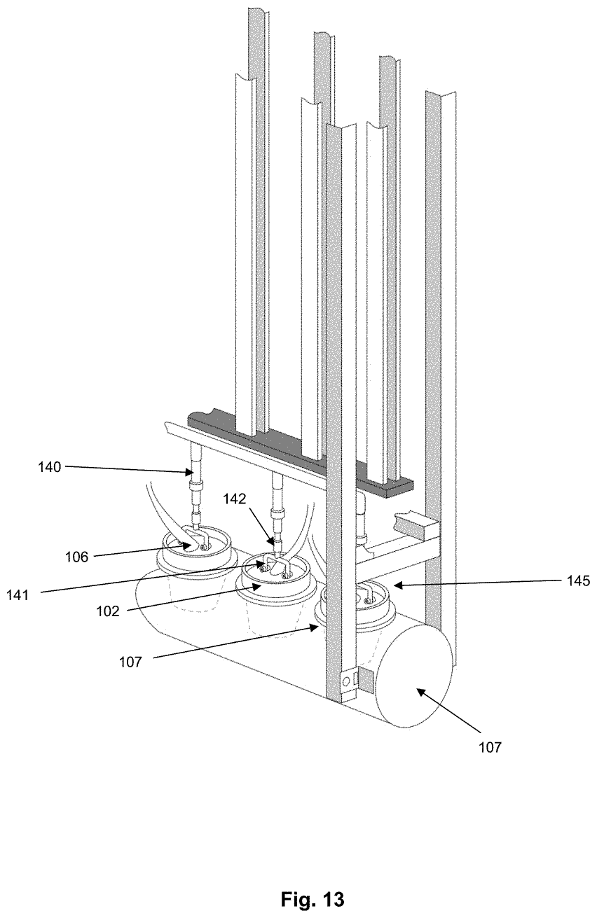

FIG. 13 shows a detailed view of the watering system of this embodiment. This improved watering system 145 allows efficient watering with little or no clogging of the watering pipes. Previous watering systems utilized smaller gauge pipes that clogged easily requiring constant monitoring and risk of underwatering the plants. This view shows the improved watering system comprising water supply 140, ball valve 142 and water outlets 141. Water supply line is a larger gauge plastic pipe, in the preferred embodiment a ¾″ pipe. This larger gauge pipe allows for rapid watering and efficient control of the water supply. Water supply 140 connects to ball valve 142. Ball valve 142 is also ¾″ and supplies the water to water outlets 141. In the preferred embodiment, there are two water outlets 141 for each cannabis plant 106. This larger water opening provides a clog-free water supply and rapid watering of the cannabis plants. Watering system 145 can be manually controlled by a typical water valve (not shown) or connected to the computer control system described in FIG. 9.

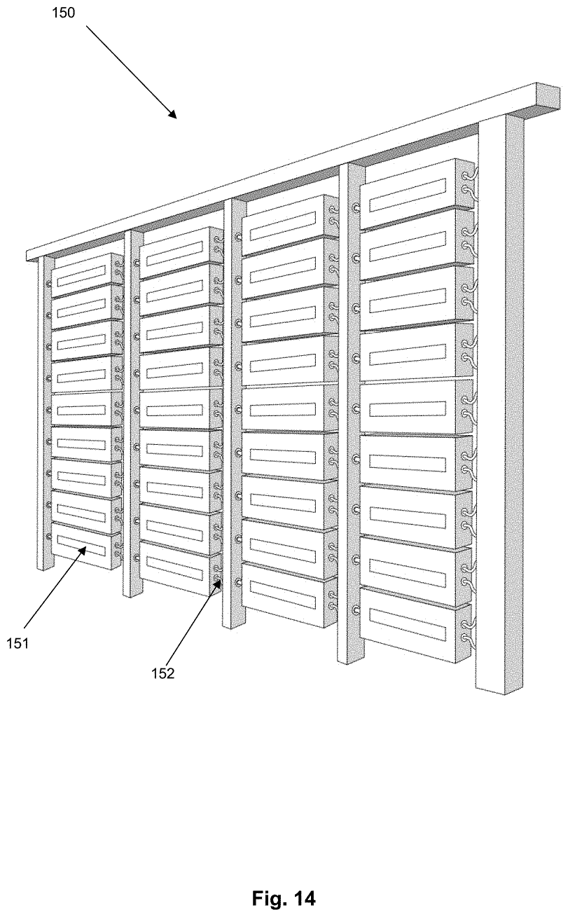

FIG. 14 shows the out of grow room ballast rack 150 of the present embodiment. This configuration allows the heat producing ballast units for the LED lighting to be located outside the grow room. Not only does it provide more space for plants to grow, but also allows the heat produced to be separated from the plants. Cannabis plants are sensitive to the temperature of the environment, which is controlled carefully, and removing these devices from the grow room allows better control of the environmental conditions in the grow room. Ballast units 151 are included in the rack with ballast wiring 152. In the preferred embodiment, 50 ballast units are included in ballast rack 150, but the size is scalable depending on the number of LED lights in the grow room. Ballast wiring 152 connects the ballast units to the LED lights 117 as shown in other figures. It is also connected to the computer control system shown in FIG. 9. In this embodiment, 5 ballast units 151 are connected in series to drive one row of LED lights.

Environmental control of the growing environment is of critical importance to the yield of cannabis output for a given grow. This embodiment includes filters that induct air from the center of the room, filter out particulates and other materials and blow it to the edges of the room. The filters used in the preferred embodiment are HEPA filters sized to filter out molds and spores and blow air at 4600CFM, but any suitable filtration system can be used. Further, in the preferred embodiment, six air conditioning units are included for the growing environment. Each air conditioning unit is 18,000 BTUs for a total of 108,000 BTUs or 9 tons of air conditioning capacity. This filtration and cooling ability allows the environmental conditions in the grow room to be monitored and adjusted carefully. The filters and air conditioning are connected to the computer control system shown in FIG. 9.

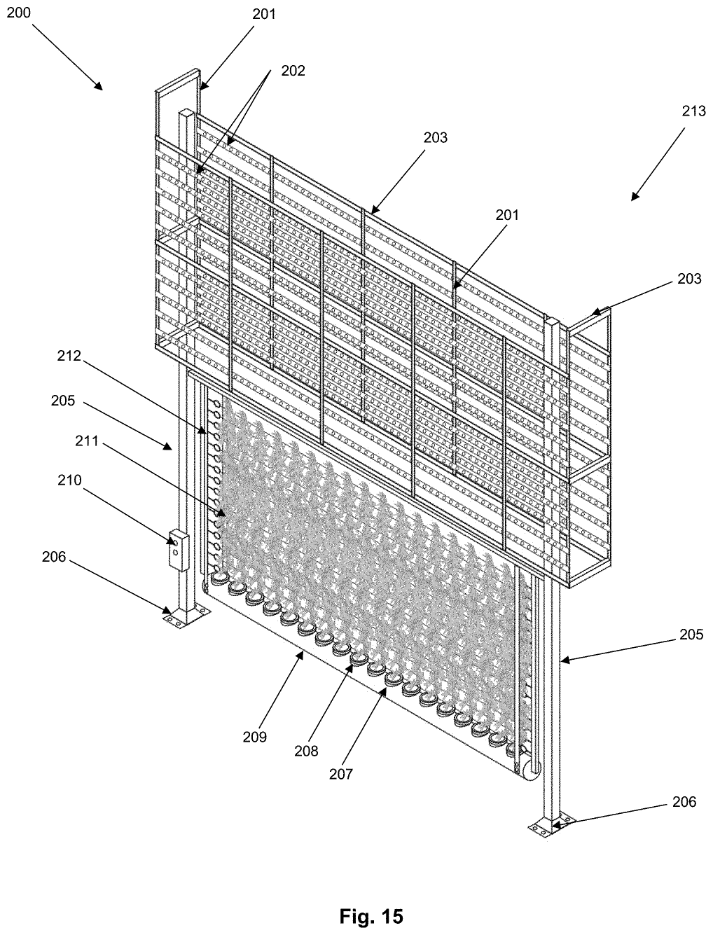

FIG. 15 shows a third potential embodiment of an improved cannabis growing system 200. In this embodiment, the cannabis plants 211 are stored toward the ceiling of the grow space, in a densely packed configuration and lowered to be trimmed, pruned, and harvested. This embodiment has two positions for the plants, raised and lowered. In this view, cannabis plants 211 are in their lowered position. In the lowered position, they can be trimmed, pruned, and harvested easily by humans. In the raised position, cannabis plants 211 are stored, and are located at the ceiling of the grow space. One of the key advantages of this embodiment is the greater density of the plant rows while in the stored position. While only one plant row 213 is shown in this view, this configuration can be built with a variable number of rows based on the available grow space. In this embodiment, cannabis plants 211 are located in potting containers 208, which are located in plant holes 207 and held by plant support 209. Plants are supported by training wires 212. Plant row 213 is raised and lowered on hydraulic lift 205. Hydraulic lift 205 could be any hydraulic lift well known in the art, particularly one with two vertical supports similar to those used in auto repair shops. In this embodiment, hydraulic lift 205 is approximately 2080 mm in height to comply with anticipated regulation requiring at least 80″ of height. The width of the lift will be modified such that each side of the lift will be approximately 20 feet apart or more. This increased width requires only a cable and hydraulic hose extension. Each row will require its own hydraulic lift 205, which for a 500 square foot room, would be 12-14 rows if the rows are 20 feet long. Example hydraulic lifts suitable for this purpose are those manufactured by Peak Lifts, but any suitable hydraulic lift known in the art could be utilized. Hydraulic lift controls 210 cause plant row 213 to be raised and lowered. Base 206 attaches hydraulic lift 205 to the floor of the grow space.

One of the other advantages of this embodiment is that in the raised position, each plant row is lighted on two sides. Vertical light support 203 is attached to horizontal light support 201 to provide support for LED lights 202. These lights provide intense light on both sides of the plant canopy and near 360 degree light coverage. The lights are of the type and can be controlled as previously discussed above. While the lights here are shown in a horizontal configuration, they could easily be located vertically or in any number of other suitable configurations.

The hydraulic lift 205 allows plant row 213 to be raised to its storage location, where it can be densely packed and brightly lit on both sides by led lights 202. The hydraulic lift 205 further allows each row to be lowered where it can be easily accessed for trimming, maintenance, pruning, harvesting any another required attention. The hydraulic lift 205 is comprised of two hydraulic lift towers in this embodiment, however other configurations are anticipated as part of this invention. This embodiment allows for twenty large 8-foot-tall plants per 20 foot row requiring floor space of just 18 inches×20 feet per row. Using smaller 3-foot-tall plants, each row could accommodate as many as 80 plants. Other suitable and efficient configurations are possible, specifically using 6 inch rockwool cubes as described below. In each configuration, the plant canopy is lit on both sides by lights, providing the most efficient grow environment.

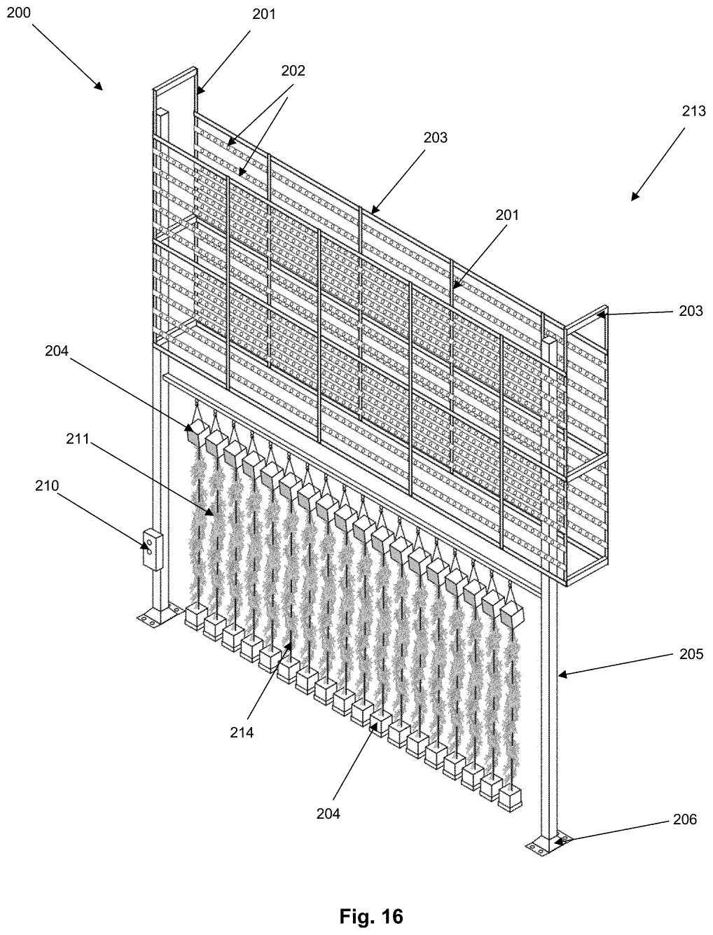

FIG. 16 shows an alternate view of the third embodiment, but instead of potting containers 208, cannabis plants 211, are located in rockwool cubes 204. Rockwool, a lightweight hydroponic substrate is made from spinning molten basaltic rock into fine fibers which are then formed into a range of cubes, blocks, growing slabs and granular products.

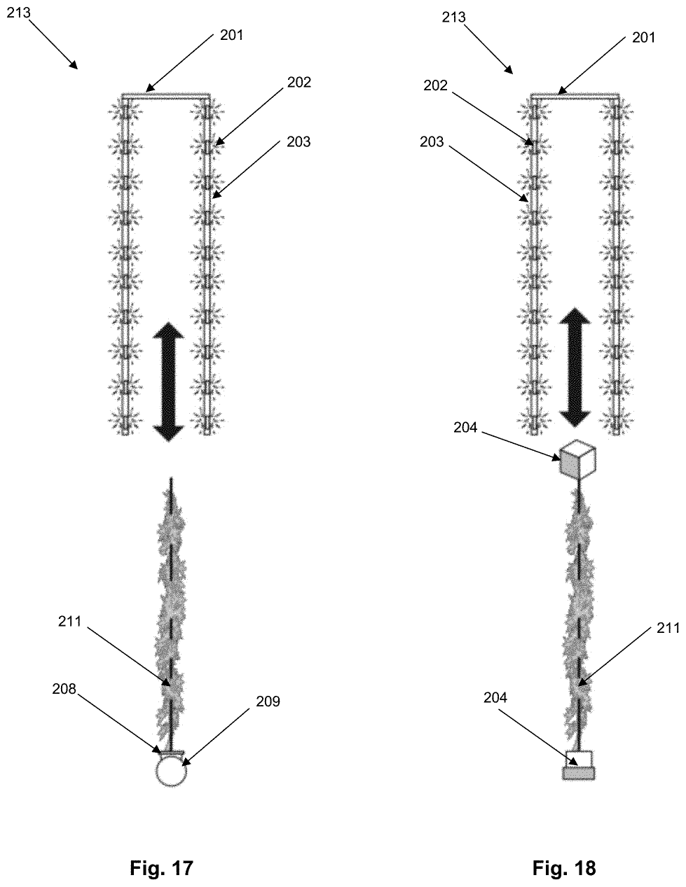

FIG. 17 is an end view of one plant row 213 of the third embodiment of the improved growing system. Here cannabis plant 211 is shown in the lowered position. Cannabis plant 211 is planted in potting container 208 which is located in plant support 209. In the raised position, horizontal light support 201 and vertical light support 203 both support LED lights 202. When raised, the plant canopy is provided with nearly 360 degree lighting coverage.

FIG. 18 is a similar end view as FIG. 17 except for the use of rockwool containers 204 for planting cannabis plants 211.

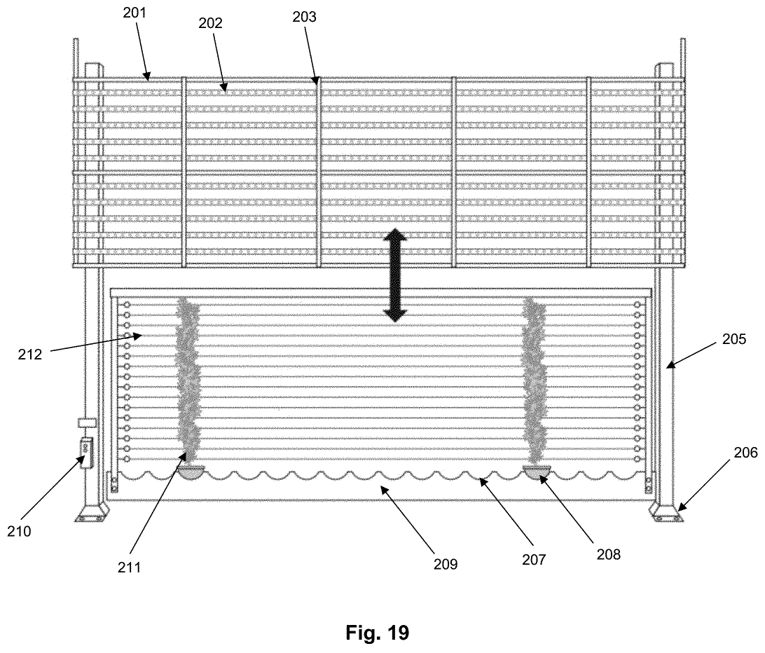

FIG. 19 is a side view of the third embodiment of the improved cannabis growing system. Plant support 209 contains plant holes 207 for storing planting containers 208, which contain cannabis plants 211. Training wires 212 support the cannabis plant 211 is it grows vertically. Hydraulic lift 205 is controlled by hydraulic lift controls 210 that enable the plant row to be raised and lowered. Hydraulic lift 205 is attached to the grow room floor with base 206. Vertical light support 203 and horizontal light support 201 support LED lights 202 which, when the plants are in the raised position, provide near 360 degree lighting coverage.

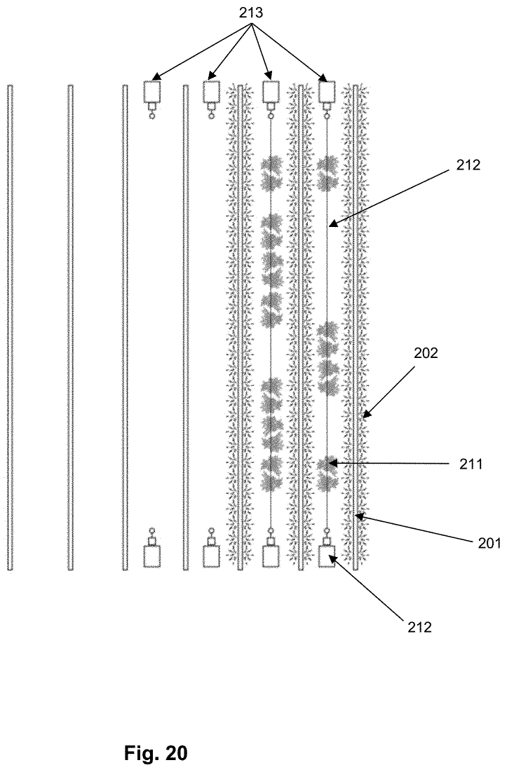

FIG. 20 is a top view of multiple plant rows 213 of the third embodiment. Here, training wires 212 are visible supporting cannabis plants 211 between LED lights 202 and horizontal light support 201.

Although the present invention has been described in relation to the above disclosed preferred embodiment, many modifications in design, materials and manufacturing are possible while still maintaining the novel claimed features and advantages of the invention. The preferred embodiment is not meant to limit the claims in any way, and the claims should be given the broadest possible interpretation consistent with the language of the disclosure on the whole.

1. An apparatus for growing cannabis comprising:
a plant support comprising an elongated body, a first end and a second end, and one or more holes in the plant support, each hole shaped to hold a potting container, each potting container sized to hold one or more cannabis plants,
a first vertical support structure attached to the first end of the plant support, the first vertical support structure having a lower end and an upper end, and a
second vertical support structure attached to the second end of the plant support the second vertical support structure having a lower end and an upper end,
a lower horizontal support structure connected between the lower end of the first vertical support structure and the lower end of the second vertical support structure,
a upper horizontal support structure connected between the upper end of the first vertical support structure and the upper end of the second vertical support structure,
one or more horizontal training wires connected between the first vertical support structure and the second vertical support structure, the horizontal training wires disposed to support the vertical growth of the cannabis plants,
one or more vertical lighting fixtures, each vertical lighting fixture having a first end and a second end, the first end of each vertical lighting fixture being attached to an upper lighting support and the second end of each vertical lighting fixture being attached to a lower lighting support, the upper lighting support being attached to a height adjustment cable, the height adjustment cable being arranged to adjust the vertical height of the vertical lighting fixtures in relation to the cannabis plants, and
the height adjustment cable having a means to move the cable to adjust the vertical height of the vertical lighting fixtures.

2. The apparatus for growing cannabis of claim 1 where the plant support is a PVC pipe.

3. The apparatus for growing cannabis of claim 1 where the first vertical support structure, the second vertical support structure, the first horizontal support structure and second horizontal support structure are made of metal slotted channel material.

4. The apparatus for growing cannabis of claim 1 where the horizontal training wires are made of metal wire and attachable to the first vertical support structure and second vertical support structure by a plug attached to each end of the wire and a key slot on the first and second vertical support structure.

5. The apparatus for growing cannabis of claim 1 where the vertical lighting fixture is comprised of LED lights.

6. The apparatus for growing cannabis of claim 1 where the vertical lighting fixture has a first and second side, with both the first and second side having lights attached.

7. The apparatus for growing cannabis of claim 1 further comprising a watering system comprising a water pipe having a first end and a second end, the water pipe arranged along the plant support member and the water pipe further comprising holes oriented to deposit water each potting container.

8. The apparatus for growing cannabis where the height adjustment cable is attached to an electric motor that adjusts the height of the vertical light fixtures.

9. The apparatus for growing cannabis of claim 7 where the vertical lighting fixtures and watering system are controlled by a computer system.

10. An apparatus for growing cannabis comprising:
a plant support comprising an elongated body, a first end and a second end, and one or more holes in the plant support, each hole shaped to support a potting container, each potting container sized to hold one or more cannabis plants,
a first vertical support structure attached to the first end of the plant support, the first vertical support structure having a lower end and an upper end, and a second vertical support structure attached to the second end of the plant support the second vertical support structure having a lower end and an upper end,
a lower horizontal support structure connected between the lower end of the first vertical support structure and the lower end of the second vertical support structure,
an upper horizontal support structure connected between the upper end of the first vertical support structure and the upper end of the second vertical support structure,
a first row support with a first gear rack, a first row movement gear attached to the upper end of the first vertical support structure, a support pipe disposed through the first row movement gear, a first ball bearing collar disposed around and supporting the support pipe, the first row movement gear arranged such that when the first row movement gear is rotated it couples with the first gear rack and moves the first vertical support structure along a horizontal plane depending on the direction of rotation of the first row movement gear,
a second row support with a second gear rack, a second row movement gear attached to the upper end of the second vertical support structure, the support pipe disposed through the second row movement gear, a second ball bearing collar disposed around and supporting the support pipe, the second row movement gear arranged such that when the second row movement gear is rotated it couples with the second gear rack and moves the second vertical support structure along a horizontal plane depending on the direction of rotation of the second row movement gear,
one or more horizontal training wires connected between the first vertical support structure and the second vertical support structure, the horizontal training wires disposed to support the vertical growth of the cannabis plants, and
one or more vertical lighting fixtures, each vertical lighting fixture arranged to project light on to the cannabis plants.

11. The apparatus for growing cannabis of claim 10 where the plant support is a PVC pipe.

12. The apparatus for growing cannabis of claim 10 where the first vertical support structure, the second vertical support structure, the first horizontal support structure and second horizontal support structure are made of metal slotted channel material.

13. The apparatus for growing cannabis of claim 10 where the horizontal training wires are made of metal wire and attachable to the first vertical support structure and second vertical support structure by a plug attached to each end of the wire and a key slot on the first and second vertical support structure.

14. The apparatus for growing cannabis of claim 10 where the vertical lighting fixture is comprised of LED lights.

15. The apparatus for growing cannabis of claim 10 where the vertical lighting fixture has a first and second side, with both the first and second side having lights attached.

16. The apparatus for growing cannabis of claim 10 further comprising a watering system comprising a water supply pipe, the water supply pipe attached to a source of water and disposed above the plant support and the cannabis plants, the water supply pipe having an individual plant watering pipe connected for each cannabis plant, the plant watering pipe further comprising a t shaped pipe having one input and two outputs, the input connected to the individual plant watering pipe and the outputs disposed to deposit water on the cannabis plant.

17. The apparatus for growing cannabis of claim 16 where the apparatus is enclosed in a room and one or more air filters for removing particulate matter from the air in the room.

18. The apparatus for growing cannabis of claim 17 further comprising one or more air conditioning units to cool the air in the room.

19. The apparatus for growing cannabis of claim 18 where the vertical lighting fixtures, watering system, air filters and air conditioning units are controlled by a computer system.

20. An apparatus for growing cannabis comprising:
a plant support comprising an elongated body, a first end and a second end, and one or more holes in the plant support, each hole shaped to hold a potting container, each potting container sized to hold one or more cannabis plants,
a first vertical support structure attached to the first end of the plant support, the first vertical support structure having a lower end and an upper end, and a second vertical support structure attached to the second end of the plant support the second vertical support structure having a lower end and an upper end, an upper horizontal support structure connected between the upper end of the first vertical support structure and the upper end of the second vertical support structure,
one or more horizontal training wires connected between the first vertical support structure and the second vertical support structure, the horizontal training wires disposed to support the vertical growth of the cannabis plants,
a hydraulic lifting means having a first hydraulic lift tower and a second hydraulic lift tower, the first hydraulic lift tower being attached to the first vertical support structure and the second hydraulic lift tower being attached to the second vertical support structure, the hydraulic lifting means moving the location of the cannabis plants between at least a first storage location and a second maintenance location,
a first lighting support structure, the first light support structure having a plurality of lights attached, the first lighting support structure being disposed at the storage location, and such that when the cannabis plants lifted to the storage location, the lights display light on a first side of the cannabis plants, and a second lighting support structure, the second light support structure having a plurality of lights attached, the second lighting support structure being disposed at the storage location, and such that when the cannabis plants lifted to the storage location, the lights display light on a second side of the cannabis plants.

21. The apparatus for growing cannabis of claim 20 where the plant support is a PVC pipe.

22. The apparatus for growing cannabis of claim 20 where the first vertical support structure, the second vertical support structure, the first lighting support structure and second lighting support structure are made of metal slotted channel material.

23. The apparatus for growing cannabis of claim 20 where the horizontal training wires are made of metal wire and attachable to the first vertical support structure and second vertical support structure by a plug attached to each end of the wire and a key slot on the first and second vertical support structure.

24. The apparatus for growing cannabis of claim 20 where the lights are comprised of LED lights.

25. An apparatus for growing cannabis comprising:
at least one plant support comprising a first rockwool container, each first rockwool container sized to hold one or more cannabis plants, a vertical wire to support the vertical growth of the cannabis plants, and a second rockwool container, the vertical wire connected to the first rockwool container at one end and the second rockwool container at a second end,
a horizontal support structure with a first end and a second end, each plant support member attached to the horizontal support structure, the horizontal support structure disposed such that the plant support structure hangs from the horizontal support structure,
a hydraulic lifting means having a first hydraulic lift tower and a second hydraulic lift tower, the first hydraulic lift tower being attached to the first end of the horizontal support structure and the second hydraulic lift tower being attached to the second end of the horizontal support structure, the hydraulic lifting means moving the location of the cannabis plants between at least a first storage location and a second maintenance location,
a first lighting support structure, the first light support structure having a plurality of lights attached, the first lighting support structure being disposed at the storage location, and such that when the cannabis plants lifted to the storage location, the lights display light on a first side of the cannabis plants, and a second lighting support structure, the second light support structure having a plurality of lights attached, the second lighting support structure being disposed at the storage location, and such that when the cannabis plants lifted to the storage location, the lights display light on a second side of the cannabis plants.

26. The apparatus for growing cannabis of claim 25 where the horizontal support structure, the first lighting support structure and second lighting support structure are made of metal slotted channel material.

27. The apparatus for growing cannabis of claim 25 where the lights are comprised of LED lights.
